(19) United States
(12) Patent Application Publication
(10) Pub. No.: US 2017/0103823 A1
(43) Pub. Date: Apr. 13, 2017

(54) GRAPHENE COATED SILVER ALLOY WIRE AND METHODS FOR MANUFACTURING THE SAME

(71) Applicant: Wire Technology Co., LTD., Taichung City (TW)

(72) Inventors: Chien-Hsun Chuang, Taichung City (TW); Hsing-Hua Tsai, Taichung City (TW)

(21) Appl. No.: 14/991,850

(22) Filed: Jan. 8, 2016

(30) Foreign Application Priority Data
Oct. 7, 2015 (TW) 104132974

(51) Int. Cl. H01B 1/02; H01B 13/16; C25D 9/08; H01B 13/00; C22F 1/14; C22F 1/02

(52) U.S. Cl. CPC H01B 1/02; C22F 1/14; C22F 1/02; C25D 9/08; H01B 13/0006; H01B 13/16

(57) ABSTRACT

A graphene coated silver alloy wire is provided. The composite wire includes a core wire and one to three layers of graphene covering surfaces of the core wire. The core wire is made of a silver-based alloy including 2 to 6 weight percent of palladium. The core wire may be optionally added with 0.01 to 10 weight percent of gold. The invention also includes a manufacturing method immersing the core wire into a solution including graphene oxide and applying bias to the core wire for manufacturing the graphene coated silver alloy wire.

### CROSS REFERENCE TO RELATED APPLICATIONS

This application claims priority of Taiwan Patent Application No. 104132974, filed on Oct. 7, 2015, the entirety of which is incorporated by reference herein.

### BACKGROUND OF THE INVENTION

Field of the Invention

The present disclosure relates to alloy wires and manufacturing methods thereof, and more specifically to alloy wires utilized for wire bonding of packages of electronic devices and manufacturing methods thereof.

Description of the Related Art

High-grade medical probe cables and transmission lines for electronic signals of audio and videos are required to be equipped with metal wires with excellent electrical and mechanical properties. Pure copper wires and copper alloy wires are often used in cables or wires required in an environment under great bending and torsional loadings, such as probe cables utilized in medical ultrasonography, signal transmission line for loudspeakers under frequent bending and torsional loadings, and source lines or signal lines utilized in computers or other consumer electronics under frequent vibrating and bending loadings, due to their properties of high strength, high ductility, low price and high electrical conductivity. However, pure copper wires and copper alloy wires tend to become oxidized and eroded, resulting in degradation of performance and/or a decrease in the reliability of the related products, or even a failure of the product. Pure silver wires or silver-copper alloy wires with high electrical conductivity are also used in transmission lines required for higher grades.

Furthermore, wire bonding is an extremely important step in the packaging processes of semiconductor devices and light emitting diodes (LED). Bonding wires provide not only signal transmission and power transmission between chips and chip carriers (substrates), but also heat dissipation performance. Therefore, it is necessary for metal wires for wire bonding to have not only excellent electrical conductivity and thermal conductivity, but also sufficient strength and ductility. Furthermore, it is necessary for the metal wires to have good antioxidative activity and corrosion resistance, because the polymer encapsulants for packaging commonly have corrosive chloride ions and hygroscopic properties absorbing moisture from the environment. Moreover, the metal wire conducts a high volume of heat to the first bond (ball bond) when the ball bond cools from the molten state to room temperature, and thus, a heat-affected zone is formed in the metal wire near the ball bond. Grain growth happens in the metal wire in the heat-affected zone due to heat build-up, resulting in the formation of local coarse grains. The local coarse grains provide a lower strength, and thus, the metal wire cracks in the heat-affected zone during the wire pull test, negatively affecting the bonding strength. When completing the packaging processes of the semiconductor devices or the light emitting diodes, the high current density through the metal wires potentially activates atoms in the metal wires and thus generate electron migration during utilization of the packaged products. As a result, holes are formed at the terminal of the metal wires, resulting in a decrease in electrical and thermal conductivity, and even the occurrence of broken wires.

The bonding wires utilized at present in the electronics industry are mainly pure gold and pure aluminum. Recently, pure copper wires have also been utilized as bonding wires. However, pure gold wires are very expensive. Furthermore, a great amount of (thick) brittle intermetallic compounds and Kirkendall voids may be formed at the interface between the gold ball bond and the aluminum pad when a pure gold wire is wire-bonded to the aluminum pad, resulting in a breakage of the connection points. The pure aluminum wires provide extremely low strength and tend to be eroded by oxidation, sulfuration and chloride ions when exposed to the environment and polymers of packaging encapsulants, resulting in low product reliability. The pure copper wires also tend to become eroded by oxidation, sulfuration and chloride ions when exposed to the environment and polymers of packaging encapsulants, resulting in low product reliability. Therefore, copper wires with noble metals such as gold, palladium or platinum coated on the surface have been developed, such as pure copper wires with gold coated on the surface as taught by U.S. Pat. No. 7,645,522B2, pure copper wires with palladium coated on the surface as taught by US 20030173659A1, and pure copper wires with platinum coated on the surface as taught by US 20030173659A1. However, the copper wires tend to become oxidized and eroded, and therefore, the corrosion and damage to the copper wires cannot be completely prevented even when the copper wires are coated with noble metals. Furthermore, the pure copper is too hard for packaging applications, and chips are often damaged when wire-bonding to IC chips and LED chips with the pure copper wires. In contrast to the case of wire-bonding to the aluminum pad with the gold wire, the growth rate of the intermetallic compounds at the interface between the copper ball bond and the aluminum pad is extremely slow when applying the copper wires to wire-bonding for packages, and therefore floating wields potentially occur.

Pure silver has an electrical resistivity of 1.63 μΩ·cm, and has the best electrical conductivity among all metals. Furthermore, pure silver has better anti-oxidization and anti-corrosion properties than copper. However, the strength of pure silver is extremely low, and pure silver also suffer from humidity corrosion and sulfuration corrosion. Furthermore, ionic migration may happen to silver wires exposed to an electrolyte when electrical current flows through the electrolyte. Silver whiskers are formed at the surfaces of the silver wires due to ionic migration, resulting in short circuits. When the silver wires are used in wire-bonding during packaging, unlike the case utilizing gold wires, a great amount of (thick) brittle intermetallic compounds and Kirkendall voids will not be formed at the interface between the silver ball bond and the aluminum pad, but the growth rate of the intermetallic compounds is still too fast. Silver-gold-palladium alloy wires taught by U.S. Pat. No. 8,101,030 B2 and U.S. Pat. No. 8,101,123 B2 provide improvements upon strength, anti-corrosion from humidity, and anti-ionic migration. An alloy wire made of a material selected from one of a group consisting of a silver-gold alloy, a silver-palladium alloy and a silver-gold-palladium alloy with a structure having plenty of annealing twins, and the same alloy wire with a gold, palladium or gold-palladium film coated on the surface are provided by TWI384082 (U.S. Pat. No. 8,940,403 B2, JP5670412, KR101328863 and CN103184362). The alloy wires provide excellent reliability and longer lifetimes during electrical current stressing. However, when the gold content in the silver alloy wires is higher, the price abruptly becomes higher, and the formation of the intermetallic compounds at the interface during wire-bonding becomes faster, resulting in the joint becoming brittle and potentially cracking. When the palladium content in the silver alloy wires is higher, the price similarly abruptly becomes higher, and the strength and hardness of the wires also abruptly becomes higher, negatively affecting the operation of wire-bonding. Furthermore, when a gold, palladium or gold-palladium film is coated on the surface of the silver alloy wires, the electrical resistivity of the resulting silver alloy composite wires will increase to a value between 3.5 and 6 μΩc·m, which is higher than that (1.63 μΩ·cm) of the pure silver wires, that (2.89 μΩ·cm) of general 2N gold wires, that (1.73 μΩ·cm) of 4N copper wires and that (1.85 μΩ·cm) of copper wires coated with palladium. Furthermore, it is also necessary to consider that the silver alloy wire also somewhat suffer corrosion and oxidization issues when exposed to an environment full of humidity or sulfur.

Thus, alloy wires and manufacturing methods thereof are required to solve the described problems.

### BRIEF SUMMARY OF THE INVENTION

An embodiment of the present disclosure provides a graphene coated silver alloy wire comprising a core wire and at least one layer of graphene covering surfaces of the core wire. The core wire is made of a silver-based alloy including 2 to 6 weight percent of palladium.

In one embodiment of the graphene coated silver alloy wire, the at least one layer of graphene includes one to three layers of graphene.

In one embodiment of the graphene coated silver alloy wire, the core wire is made of a silver-palladium alloy including 2 to 6 weight percent of palladium and a balance of silver.

In one embodiment of the graphene coated silver alloy wire, it is preferred that the silver-based alloy further includes 0.01 to 10 weight percent of gold.

In one embodiment of the graphene coated silver alloy wire, the silver-palladium alloy further includes 0.01 to 10 weight percent of gold and the balance of silver.

In one embodiment of the graphene coated silver alloy wire, a diameter of the core wire is between 10 μm and 300 μm.

In other embodiments of the present disclosure, a manufacturing method of a graphene coated silver alloy wire is provided. First, a thick wire is provided. The thick wire is made of a silver-based alloy including 2 to 6 weight percent of palladium. Then, a wire diameter of the thick wire is step-by-step decreased to form a fine wire with a wire diameter less than that of the thick wire as a core wire of the graphene coated silver alloy wire utilizing alternative performance of a plurality of cold work shaping steps and a plurality of annealing steps. Next, the core wire is immersed into a solution including graphene oxide. Next, the graphene oxide is attached to the core wire and simultaneously the attached graphene oxide is reduced into at least one layer of graphene covering surfaces of the core wire utilizing applying bias to the core wire.

In one embodiment of the method, the cold work shaping steps are wire drawing steps, extrusion steps or a combination thereof.

In one embodiment of the method, the annealing steps are performed under a passivation atmosphere.

In one embodiment of the method, the provision of the thick wire comprises steps of: melting raw materials of the material of the thick wire, followed by casting to form an ingot; and performing cold work on the ingot to complete the thick wire.

In one embodiment of the method, the provision of the thick wire comprises steps of melting raw materials of the material of the thick wire, followed by a process of continuous casting to form the thick wire.

In one embodiment of the method, the step of the annealing steps after the completion of the diameter of the fine wire is performed at an annealing temperature between 500° C. and 600° C. during an annealing period between 3 seconds and 60 seconds.

In one embodiment of the method, the bios is between 0.5 and 2 volts.

In one embodiment of the method, a wire diameter of the thick wire is between 5 mm and 10 mm, and a wire diameter of the fine wire is between 10 μm and 300 μm.

In one embodiment of the method, the at least one layer of graphene includes one to three layers of graphene.

In one embodiment of the method, the thick wire is made of a silver-palladium alloy including 2 to 6 weight percent of palladium and a balance of silver.

In one embodiment of the method, the silver-based alloy further includes 0.01 to 10 weight percent of gold.

In one embodiment of the method, the silver-palladium alloy further includes 0.01 to 10 weight percent of gold and the balance of silver.

Furthermore, the scope of the applicability of the invention will become apparent from the detailed descriptions given herein. It should be understood however, that the detailed descriptions and specific examples, while indicating preferred embodiments of the invention, are given by way of illustration only, as various changes and modifications within the spirit and scope of the invention will become apparent to those skilled in the Art from the detailed descriptions.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1A schematically illustrates a wire segment of a graphene coated silver alloy wire of an embodiment of the present disclosure;

FIG. 1B is a lengthwise cross-section of the graphene coated silver alloy wire shown in FIG. 1A along a direction parallel to the longitudinal direction of the graphene coated silver alloy wire shown in FIG. 1A;

FIG. 2 is a flow chart showing an example of a manufacturing method of the graphene coated silver alloy wire of the an embodiment of the present disclosure;

FIG. 3 is a flow chart showing an example of provision of the thick wire in the flowing charts shown in FIG. 2;

FIG. 4 schematically shows another example of provision of the thick wire in the flowing charts shown in FIG. 2; and

FIG. 5 schematically illustrates steps relate to the performance about covering the surfaces of the core wire with graphene layer or layers.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Note that the concepts and specific practice modes of the invention is described in detail by the embodiments and the attached drawings. In the drawings or description, similar elements are indicated by similar reference numerals and/or letters. Furthermore, the element shape or thickness in the drawings can be expanded for simplification or convenience of indication. Moreover, elements which are not shown or described can be in every form known by those skilled in the art.

It should be understood that the following disclosure provides many different embodiments, or examples, for implementing different features of the invention. Specific examples of components and arrangements are described below to simplify the present disclosure. These are merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples.

In the subsequent description, phrases such as “substantially the same” . . . etc. mean the compared elements, components, conditions, . . . etc. are expected to be the same in design, as in practice, it is difficult to be measured to be mathematically or theoretically the same due to limits and errors of the practical measurement. Additionally, when deviation is in an acceptable range of a corresponding standard or specification, it is also recognized to be the same. Those skilled in the art are expected to acknowledge, that different standards or specifications, depend upon various properties and conditions, and thus, cannot be specifically listed.

Specific embodiments of the invention for graphene coated silver alloy wires and manufacturing methods thereof are described. It is noted that the concepts of the invention can be applied to any known or newly developed graphene coated silver alloy wires and manufacturing methods thereof.

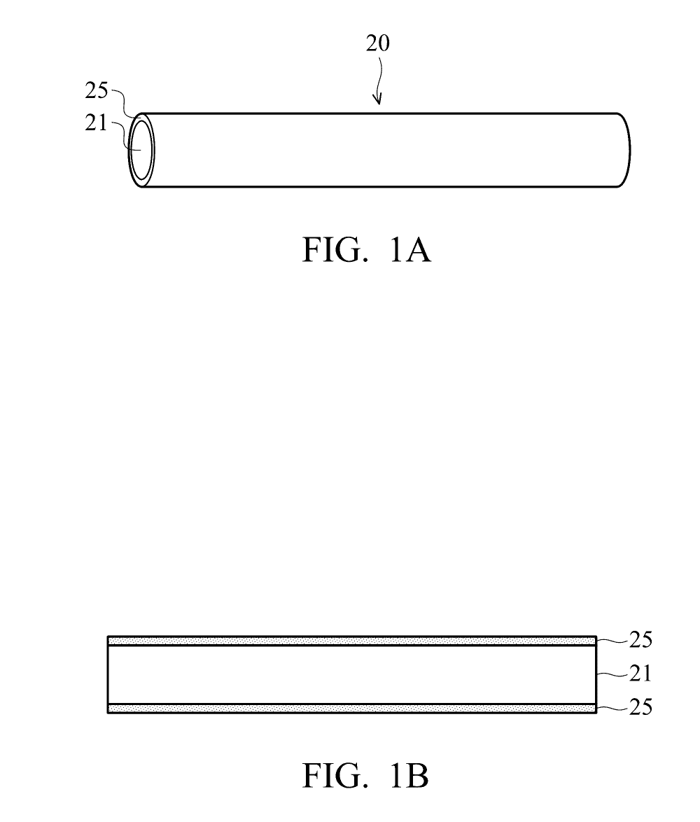

Referring to FIGS. 1A and 1B showing a graphene coated silver alloy wire 20 of an embodiment of the present disclosure, FIG. 1A schematically illustrates a wire segment of the graphene coated silver alloy wire 20 of the embodiment of the present disclosure, and FIG. 1B is a lengthwise cross-section of the graphene coated silver alloy wire 20 shown in FIG. 1A along a direction parallel to the longitudinal direction of the graphene coated silver alloy wire 20 shown in FIG. 1A.

As shown in FIGS. 1A and 1B, the graphene coated silver alloy wire 20 of the embodiment of the present disclosure comprises a core wire 21 and at least one layer 25 of graphene. The at least one layer 25 of graphene covers surfaces of the core wire 21.

The core wire 21 is made of a silver-based alloy including 2 to 6 weight percent of palladium. In one embodiment, the core wire 21 is made of a silver-palladium alloy including 2 to 6 weight percent of palladium and a balance of silver. In an alternative embodiment, the core wire 21 is made of a silver-gold-palladium alloy including 2 to 6 weight percent of palladium, 0.01 to 10 weight percent of gold and a balance of silver. In an alternative embodiment, other element or elements can be optionally added to the silver-based alloy including 2 to 6 weight percent of palladium to a suitable concentration to form the core wire 21. For example, 0.01 to 10 weight percent of at least one of a group consisting of gold, copper and nickel can be optionally added to the silver-based alloy including 2 to 6 weight percent of palladium to form the core wire 21.

Furthermore, wire diameters of the core wire 21 can be properly selected according to the predetermined application, such as to medical probe cables, transmission lines for electronic signals of audios and videos, bonding wires for packages of electronic devices used in a high frequency field or other applications, of the graphene coated silver alloy wire 20 of the embodiment of the present disclosure. In one embodiment, the diameter of the core wire 21 is between 10 μm and 300 μm, which are suitable for wires utilized in wire bonding for packages of electronic devices. Note that a user can also apply the inventive alloy wires to other technical fields and purposes, such as enamelled wires, audio wires, signal or power transmission wires, voltage transformer wires . . . etc. as desired. The wire diameter of the core wire 21 may also be modified as desired, and is not limited in the described exemplary range.

In one embodiment, the reduced graphene layer 25 can be a single-layered structure if the reduced graphene layer 25 substantially completely covers the core wire 21. In an alternative embodiment, if there is defect in the single-layered structure, the reduced graphene layer 25 can be a two-layered or three-layered structure to substantially completely cover the core wire 21. Every layer of the two-layered or three-layered structure is a graphene structure based on the chemical structure of single-layered graphite. In a situation where the reduced graphene layer 25 can be a two-layered structure, a three-layered structure or a multi-layered structure having more than three layers, there is no chemical bond between any of the layers.

Although the conventional silver-gold-palladium alloy wires provide improvements in wire strength, anti-corrosion properties against humidity, and ionic migration, it is difficult to solve the problems of corrosion, low reliability, and damage to chips that occurs when employing technologies that utilize copper wires. This may also overcome the drawbacks of high prices, and cracks forming at the joint interface due to fast growth of intermetallic compounds. These can occur when employing technologies that utilize gold wires. The electrical resistivity of the silver alloy wires may apparently increase if somewhat elemental gold and/or palladium are added to the silver alloy wire. The silver alloy wires with gold and/or palladium may be slightly eroded or oxidized during exposure to an environment with high humidity or sulfur for a long period. In order to enhance the performance of the silver alloy wires even further, an embodiment of the present disclosure provides a silver-based alloy wire (e.g. a silver-palladium alloy wire or a silver-gold-palladium alloy wire) acting as a core wire with one to three layers of graphene coated on the surfaces thereof.

The graphene has a thermal conductivity greater than 4,000 Wm⁻¹K⁻¹, an electron transmission rate greater than 10⁶ cm²V⁻¹S⁻¹, an electrical resistivity as low as 10⁻⁶ μΩ·cm, a tensile strength as high as 125 GPa or higher, a density as high as 2.2 g/cm³ or higher. When covering the surfaces of the silver-based alloy wire with graphene, the structure of graphene can block oxygen and sulfur, and therefore, the core wire of silver-based alloy can be protect from corrosion and oxidization, or at least the corrosion rate and oxidization rate of the core wire of silver-based alloy can be decreased. However, it is necessary for the graphene layer covering the surfaces of the core wire to have at least complete single layer, which is the threshold for protecting the core wire of silver-based alloy. On the other hand, if too many layers of graphene are formed, the three-dimensional graphite structure will be formed, and the properties of graphene will disappear. Therefore, one of the preferred structures is the one to three layers of graphene covering the core wire of silver-based alloy. It is preferred that the core wire of silver-based alloy comprises 2 to 6 weight percent of palladium with or without 0.01 to 10 weight percent of gold with correspondence to the structure of graphene covering the core wire of silver-based alloy, resulting in the complete silver alloy composite wire having not only high resistance to oxidation, but also excellent strength, excellent ductility and excellent reliability.

Conventionally, graphene is grown on a surface of a material mainly by a chemical vapor deposition. Specifically, CH₄ or C₂H₂ gas is induced at a high temperature between 700° C. and 1000° C., resulting in depositing carbon atoms on surfaces of a metal substrate to form graphene. However, only copper or nickel can be utilized as the metal substrate in the process, and the grains of the copper or nickel substrate may become extremely great due to the extremely high temperature. If the substrate is a copper or nickel wire, the copper or nickel wire will deform to have a bamboo-like profile due to grain growth under the extremely high temperatures, resulting in an abrupt decrease in strength and elongation. In the present disclosure, the metal wire is immersed into a solution comprising graphene oxide, followed by applying bias to the metal wire utilizing the electrochemical mechanism to attach graphene oxide to the surfaces of the metal wire and simultaneously provide electrons to reduce graphene oxide into a graphene film covering the surfaces of the metal wire. The process temperature is between room temperature and 100° C., and therefore the grains of the metal wire are not coarsened, and the strength and ductility thereof can be kept. More advantageously, the metal wire is not limited to copper or nickel used in the conventional chemical vapor deposition. According to the example 1 listed below, the fact one to three layers graphene can be successfully grown on surfaces of a silver alloy wire is verified. The corrosion potential performance of the resulting wire is better than that of the original wire, and the electrical resistivity of the resulting wire is lower than that of the original wire.

The present disclosure provides a manufacturing method of a graphene coated silver alloy wire different from the conventional technology. In the method, a core wire is immersed into a solution comprising graphene oxide, followed by applying bias to reduce the graphene oxide into a graphene film covering the surfaces of the alloy wire. This is how the graphene coated silver alloy wire is manufactured.

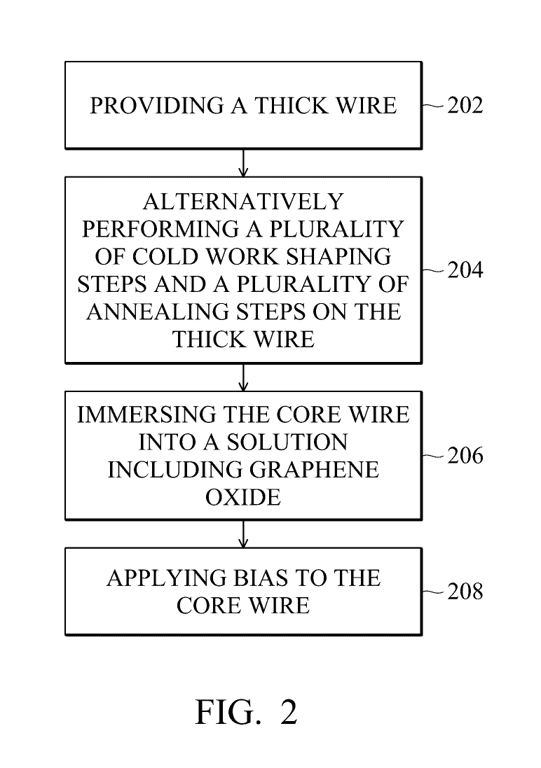

Specifically, referring to the flow chart shown in FIG. 2, an exemplary embodiment of the manufacturing method of the graphene coated silver alloy wire may comprise the subsequent steps 202, 204, 206 and 208.

In step 202, a thick wire made of a silver-based alloy including 2 to 6 weight percent of palladium is provided.

In step 204, a wire diameter of the thick wire is step-by-step decreased to form a fine wire with a wire diameter less than that of the thick wire utilizing alternative performance of a plurality of cold work shaping steps and a plurality of annealing steps. The fine wire is acted as a core wire of the graphene coated silver alloy wire.

In step 206, the core wire is immersed into a solution including graphene oxide.

In step 208, the graphene oxide is attached to the core wire and simultaneously the attached graphene oxide is reduced into at least one layer of graphene covering surfaces of the core wire utilizing applying bias to the core wire.

In the steps that have been described, the diameter of the thick wire may be between 5 mm and 10 mm. After steps 202 and 204, the diameter of the resulting fine wire is between 10 μm and 50 μm in one embodiment, and between 10 μm and 300 μm in an alternative embodiment. As described above, the fine wire can be utilized as the core wire 21 as shown in FIGS. 1A and 1B, and the graphene coated silver alloy wire 20 of the embodiment of the present disclosure can be used as a bonding wire in wire-bonding technology.

In the steps that have been described, the thick wire may be made of a silver-palladium alloy including 2 to 6 weight percent of palladium and a balance of silver.

In the steps that have been described, the thick wire may further includes 0.01 to 10 weight percent of gold.

In the steps that have been described, the silver-palladium alloy further includes 0.01 to 10 weight percent of gold and the balance of silver.

In step 204, the cold work shaping steps may be wire drawing steps, extrusion steps or a combination thereof.

In step 204, the annealing steps may be performed under a passivation atmosphere. The passivation atmosphere can be nitrogen atmosphere, an atmosphere of inert gas or a combination thereof.

In step 204, the step of the annealing steps after the completion of the diameter of the fine wire may be performed at an annealing temperature between 500° C. and 600° C. during an annealing period between 3 seconds and 60 seconds. As a result, the grain growth in the resulting fine wire can be suppressed, the mechanical properties of the fine wire can be enhanced, and the reliability performance, especially the reliability performance after wire-bonding of the graphene coated silver alloy wire 20 of the embodiment of the present disclosure may be improved.

In the described method, an example of a method of provision of the thick wire may comprise the subsequent cast step 302 and cold work step 304.

In the cast step 302, raw materials of the material of the thick wire are heated and melted, followed by casting to form an ingot.

In the cold work step 304, the step performs cold work on the ingot to complete the thick wire. Similarly, the cold work step 304 can also be a wire drawing step, an extrusion step or a combination thereof.

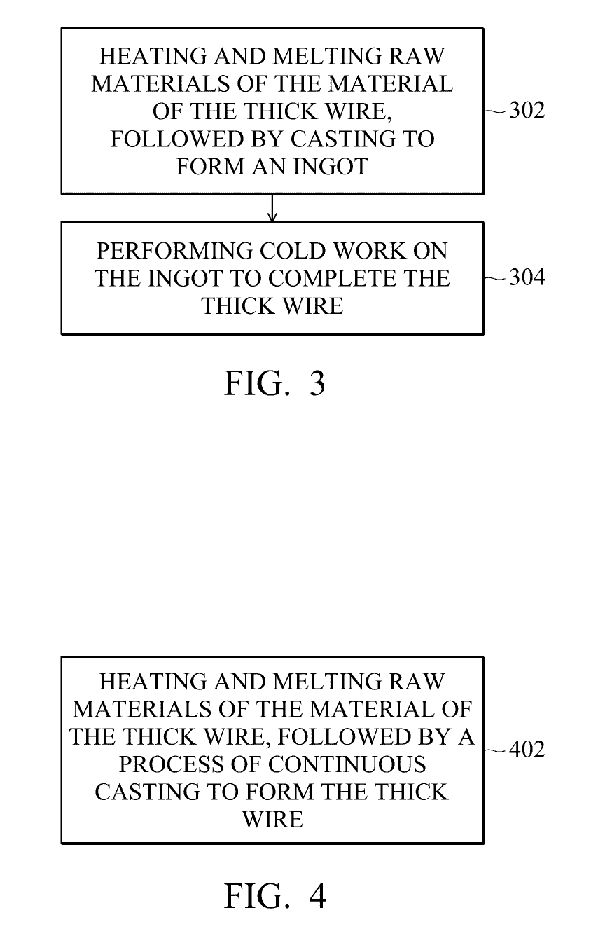

In the described method, another example of a method of provision of the thick wire preferable comprises the subsequent continuous casting step 402 with reference to the schematic drawing shown in FIG. 3.

In the continuous casting step 402, raw materials of the material of the thick wire are heated and melted, followed by a process of continuous casting to form the thick wire.

Next, details of the described steps 206 and 208 are further discussed.

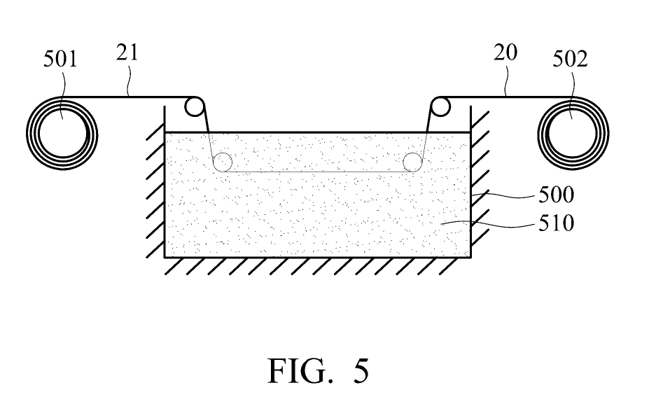

Referring to FIG. 5 that schematically illustrates steps (the described steps 206 and 208) relate to the performance about covering the surfaces of the core wire with graphene layer or layers.

In step 206, the fine wire completed by step 204 is utilized as the core wire 21 and is coiled on a line shaft 501. Then, the core wire 21 is uncoiled and pulled out from the line shaft 501, followed by immersing the core wire 21 into an electrolytic tank 500 comprising a solution 510 including graphene oxide to attach graphene oxide to the surfaces of the core wire 21 and simultaneously reduce the attached graphene oxide into graphene layer or layers covering the surfaces of the core wire 21. The resulting graphene coated silver alloy wire 20 of the embodiment of the present disclosure is then coiled on the line shaft 502. The immersing depth of the core wire 21 in the solution 510 can be properly adjusted as required. In one embodiment, the solution 510 is received in the electrolytic tank 500, and the solution 510 is the solution where graphene oxide is dispersed in water with a concentration between 0.01 g/l and 1 g/l, for example. In an alternative embodiment, water acted as a dispersion medium can be replaced by a polar solvent which does not chemically react with the core wire 21. The concentration of graphene oxide can be properly adjusted as required, and is not limited to the described range.

A platinum electrode (not shown), for example, acted as an anode, and the core wire 21, acted as a cathode, are respectively electrically connected to the same power source (not shown). The anode and the cathode (core wire 21) are also immersed together into the solution 510 and are separated from each other with a predetermined distance in the solution 510. The predetermined distance may be properly adjusted as required. Furthermore, a reference electrode (not shown) may further be disposed between the anode and the core wire 21 acted as the cathode. The reference electrode is also electrically connected to the power source and immersed in the solution 510. The immersion depth of the reference electrode in the solution 510 can also be properly adjusted as required. In FIG. 5, the anode, the power source and the reference electrode are not shown.

The reference electrode can be a hydrogen electrode, a silver/silver chloride electrode or a calomel electrode. In step 208, the bios applying to the anode and the cathode (core wire 21) is adjusted relatively according to the type of the selected reference electrode. In this embodiment, the hydrogen electrode is utilized as the reference electrode, while the bios applying to the core wire 21 is preferably between 0.5 to 2 volts, and a current region is preferably between −5 mA and +5 mA.

In step 208, an immersing period of the core wire 21 in the solution 510 (reaction period) is controlled to be between 5 seconds and 60 seconds, for example, due to the properly controlled speed of the core wire 21 from the line shaft 501 through the solution 510 in the electrolytic tank 500 to the line shaft 502 to continuously pass the core wire 21 through the solution 510. Under the bios and the condition of the current region, the graphene oxide is attached to the core wire 21 from the solution 510, and the attached graphene oxide is simultaneously reduced into the graphene layer or layers 25 covering the core wire 21 as shown in FIGS. 1A and 1B. At this time, the graphene layer or layers attached to the core wire 21 can be as thick as a range between 10 nanometers and 1 micrometer.

As described, the graphene layer or layers 25 covering the surfaces of the silver alloy wire can be a single-layered structure, a two-layered structure, a three-layered structure or even a multi-layered structure more than three layers, which can be controlled by the control of parameters such as the concentration of graphene oxide in the solution 510, the bios and the current region applying to the core wire 21, moving speed of the core wire 21 (the immersing period in the solution 510).

An example is described. However, the present disclosure is not limited to the example given.

### Example 1

A silver-4 wt % palladium alloy was smelted by high-frequency electric smelting, followed by continuous casting to form a thick wire with a wire diameter of 6 mm. The thick wire became an initial wire with a wire diameter of 1 mm after an initial drawing step, and then it became a fine wire with a wire diameter of 17.6 μm after alternative performance of a plurality of steps including wire drawing elongation steps and annealing treatment steps, followed by the performance of the last step of the annealing treatment at an annealing temperature of 570 C for 4.8 seconds. Every step of the annealing treatment was performed at a nitrogen passive atmosphere. Completing the last step of the annealing treatment, the fine wire acted as a core wire was sent to be immersed into and passed a solution including graphene oxide with 1V bias applied, such that graphene oxide was attached to the fine wire and the attached graphene oxide was simultaneously reduced into graphene layer or layers covering the surfaces of the Ag-4Pd core wire. The graphene coated silver alloy wire was then coiled to complete the product of a silver alloy composite wire.

In order to verify the formation or growth of graphene, the completed graphene coated silver alloy wire was inspected by a raman spectrometer, and the result showed one layer of graphene was grown at the surfaces of the graphene coated silver alloy wire. The results from other inspections showed the graphene coated silver alloy wire has an electrical resistivity of 2.96 μΩ·cm, lower than that (3.54 μΩ·cm) of the original Ag-4Pd alloy, and a corrosion potential of −72 mV in a bath of an aqueous solution of 3% NaCl, much lower than that (−149 mV) of the original Ag-4Pd alloy. That means the graphene coated Ag-4Pd alloy wire has lower corrosion tendency.

While the invention has been described by way of example and in terms of preferred embodiment, it is to be understood that the invention is not limited thereto. On the contrary, it is intended to cover various modifications and similar arrangements (as would be apparent to those skilled in the Art). Therefore, the scope of the appended claims should be accorded the broadest interpretation so as to encompass all such modifications and similar arrangements.

What is claimed is:

1. A graphene coated silver alloy wire, comprising:
a core wire made of a silver-based alloy including 2 to 6 weight percent of palladium; and
at least one layer of graphene covering surfaces of the core wire.

2. The alloy wire as claimed in claim 1, wherein the at least one layer of graphene includes one to three layers of graphene.

3. The alloy wire as claimed in claim 1, wherein the core wire is made of a silver-palladium alloy including 2 to 6 weight percent of palladium and a balance of silver.

4. The alloy wire as claimed in claim 1, wherein the silver-based alloy further includes 0.01 to 10 weight percent of gold.

5. The alloy wire as claimed in claim 3, wherein the silver-palladium alloy further includes 0.01 to 10 weight percent of gold and the balance of silver.

6. The alloy wire as claimed in claim 1, wherein a diameter of the core wire is between 10 μm and 300 μm.

7. A manufacturing method of a graphene coated silver alloy wire, comprising:
providing a thick wire made of a silver-based alloy including 2 to 6 weight percent of palladium;
step-by-step decreasing a wire diameter of the thick wire to form a fine wire with a wire diameter less than that of the thick wire as a core wire of the graphene coated silver alloy wire utilizing alternative performance of a plurality of cold work shaping steps and a plurality of annealing steps;
immersing the core wire into a solution including graphene oxide; and
attaching the graphene oxide to the core wire and simultaneously reducing the attached graphene oxide into at least one layer of graphene covering surfaces of the core wire utilizing applying bias to the core wire.

8. The method as claimed in claim 7, wherein the cold work shaping steps are wire drawing steps, extrusion steps or a combination thereof.

9. The method as claimed in claim 7, wherein the annealing steps are performed under a passivation atmosphere.

10. The method as claimed in claim 7, wherein the provision of the thick wire comprises the following steps:
melting raw materials of the material of the thick wire, followed by casting to form an ingot; and
performing cold work on the ingot to complete the thick wire.

11. The method as claimed in claim 7, wherein the provision of the thick wire comprises steps of melting raw materials of the material of the thick wire, followed by a process of continuous casting to form the thick wire.

12. The method as claimed in claim 7, wherein the step of the annealing steps after the completion of the diameter of the fine wire is performed at an annealing temperature between 500° C. and 600° C. during an annealing period between 3 seconds and 60 seconds.

13. The method as claimed in claim 7, wherein the bios is between 0.5 and 2 volts.

14. The method as claimed in claim 7, wherein a wire diameter of the thick wire is between 5 mm and 10 mm, and a wire diameter of the fine wire is between 10 μm and 300 μm.

15. The method as claimed in claim 7, wherein the at least one layer of graphene includes one to three layers of graphene.

16. The method as claimed in claim 7, wherein the thick wire is made of a silver-palladium alloy including 2 to 6 weight percent of palladium and a balance of silver.

17. The method as claimed in claim 7, wherein the silver-based alloy further includes 0.01 to 10 weight percent of gold.

18. The method as claimed in claim 17, wherein the silver-palladium alloy further includes 0.01 to 10 weight percent of gold and the balance of silver.
